(19) United States
(12) Patent Application Publication
(10) Pub. No.: US 2003/0023335 A1
(43) Pub. Date: Jan. 30, 2003

(54) Method and system for managing banks of drawing numbers

(76) Inventors: Phyllis R. Budka, Niskayuna, NY (US); Michael Sobolewski, Clifton Park, NY (US)

Correspondence Address: PERKINS COIE LLP, PATENT-SEA, P.O. BOX 1247, SEATTLE, WA, 98111-1247, US

(21) Appl. No.: 09/917,249

(22) Filed: Jul. 26, 2001

(51) Int. Cl. G06F 7/00

(52) U.S. Cl. 700/103; 707/102

(57) ABSTRACT

A computer-based drawing number system is provided that coordinates the request for information about drawing numbers, the issuance of new blocks of drawing numbers, and searches for drawing numbers. The drawing number system may include an exact number component, a search component, an update component, an issue block component, a web engine component, a server engine component, and a variety of databases. The issue block component may be used to issue the next available block of drawing numbers to a requester. A branch bank computer may be used to request new blocks of drawing numbers and to distribute those drawing numbers to users when requested to do so. The drawing number system may accommodate other types of document numbers besides drawing numbers. The drawing number system may be implemented in a client/server environment, such as a web-based environment over the Internet. In such an environment, a web server provides the various components of the drawing number system.

### TECHNICAL FIELD

The described technology relates generally to computer-based drawing number systems and, in particular, to drawing number management systems.

### BACKGROUND

In many businesses, there is the need to have documents, particularly technical and/or mechanical drawings, available for access over an extended period of time. For example, a power plant may have equipment that has a lifetime of 20 to 40 years. During its lifetime, the equipment may need to be maintained or upgraded. It is important to have the drawings depicting the equipment available in order to properly maintain and upgrade that equipment. If such drawings are not available, then the maintenance or upgrade may only be possible by estimating or measuring the characteristics or dimensions of the equipment. In some instances, it may not even be possible to maintain or upgrade the equipment if the drawings are not available. Thus, if the drawings are not available, then the cost of operating the equipment may increase dramatically or the equipment may become useless. To help ensure that drawings are available, many companies use a unique drawing number to identify each drawing so that it can be readily identified and located.

In many cases, a large company may use different and inconsistent formats for its drawings numbers. These inconsistencies often result from the autonomy given to organizations, such as divisions of a company, which may have originated within the company itself or been acquired in a merger, acquisition, or similar transaction. Each organization may have its own drawing number format that is inconsistent with the format of other organizations. For example, one organization may use a numbering format that consists of 5-7 alphabetic or numeric characters and another organization may use a format that consists of 6 numeric characters. A drawing number of “123456” is valid in both formats, and thus each organization may assign the same drawing number to different drawings.

Because the internal structure of responsibilities within a company may change over time, different organizations may be responsible for a certain drawing at different times. For example, the responsibility for a drawing may initially be within an organization that manufactures the part depicted in the drawings. After the company decides to stop manufacturing the part, the responsibility may be transferred to a maintenance organization. The association for the appropriate drawing numbers should be changed as well. By knowing this association, the drawing number can be used to identify whom to contact to request a new part or to obtain information about a part. When the owner of a piece of equipment needs to order a new part, they could look up the organization associated with the drawing number to determine whom to contact to order a replacement part. Without this knowledge, it could be difficult to find the organization responsible for a part.

Companies typically manually maintain the lists of assigned drawing numbers and their associated organization in a paper-based book. For a large company, this book, known as an order data book, can have hundreds of thousands or even millions of entries, making it very large, unwieldy, and expensive to maintain. Additionally, copies of this book may be sent to each organization that creates additional expense and complications with keeping the books current. It is time consuming to look up information about a drawing number in such a large book, and it is very inefficient to send new copies of the book out every time the organization responsible for a drawing changes or new drawing numbers are added.

Often an organization may desire a new block of drawing numbers that can be used to uniquely identify new drawings as they are produced by draftspersons or engineers. Typically, a representative of an organization contacts a person in charge of the drawing number book and requests a block. This person manually determines the next available block of drawing numbers, selects the block, sends the information back to the representative, and records the issuance of the drawing numbers to that organization. This process is labor-intensive, time-consuming, and prone to error.

It would be desirable to have a drawing number management system that reduces the overall cost of maintaining drawings, increases the availability of the drawings and information about the drawings, and provides a quick and accurate way of distributing new blocks of drawing numbers.

### BRIEF DESCRIPTION OF DRAWINGS

FIGS. 1-13 are web pages that illustrate the user interface of the drawing number system in one embodiment.

FIG. 14 is a block diagram illustrating components used to implement the drawing number system in one embodiment.

FIG. 15 is a flow diagram illustrating the processing of a request to search for an exact drawing number in one embodiment.

FIGS. 16A-16B are flow diagrams illustrating the processing of a request to search for a drawing number in one embodiment.

FIG. 17 is a flow diagram illustrating the processing of a request for a block of numbers in one embodiment.

FIG. 18 is a flow diagram illustrating the processing of a determine next available block function in one embodiment.

FIG. 19 is a flow diagram illustrating the processing of a calculate drawing number function in one embodiment.

FIG. 20 illustrates data structures of a drawing number database in one embodiment.

FIG. 21 is a web page that illustrates the user interface of the drawing number system in one embodiment.

FIG. 22 illustrates the data structure of a number requester database in one embodiment.

FIG. 23 illustrates the data structure of an issued block database in one embodiment.

FIG. 24 is a block diagram illustrating components used to implement the drawing number system in one embodiment.

FIG. 25 is a block diagram illustrating components used to implement the drawing number system in one embodiment.

FIG. 26 is a flow diagram illustrating the processing of a request to issue an individual drawing number in one embodiment.

FIG. 27 is a flow diagram illustrating the processing of a determine next available drawing number function in one embodiment.

FIG. 28 is a flow diagram illustrating the processing of a request to be issued an individual drawing number from a user in one embodiment.

### DETAILED DESCRIPTION

A computer-based drawing number system, particularly a drawing number management system, is provided that coordinates the request for information about drawing numbers, the issuance of new blocks of drawing numbers to organizations, the issuance of individual drawing numbers to users, and searches for drawing numbers. In one embodiment, the drawing number system includes an exact number component, a search component, an update component, an admin request component, an issue block component, a web engine component, a server engine component, and a variety of databases. The databases contain lists of issued drawing numbers, include both active drawing number formats and legacy drawing number formats.

In one embodiment, the exact number search component is used to search for information about a particular drawing number, providing a much quicker and more up to date search than those conducted with paper books. A variety of pieces of information are available about each drawing number, including the organization responsible for the drawing or component depicted in the drawing. If responsibility for a drawing has changed over time, this will be reflected in the displayed information. The search component can also be used to search for drawing numbers when the exact number is not known. For example, if a subset of the drawing number is input (e.g. only a prefix but not a suffix), the search component will return data about all drawing numbers that match the inputted information.

In one embodiment, an issue block component issues the next available block of drawing numbers to a requester. A requestor is a user that has authority to request a block of numbers. Drawing numbers are typically issued in blocks to a particular organization, and someone within the organization will be responsible for distributing the drawing numbers to draftspersons for use with new drawings. Blocks of drawing numbers usually are issued in sequence, and the issue block component will calculate the first and last drawing numbers in a block. The issue block component eliminates the need for an administrator to manually distribute blocks of drawing numbers to organizations within a company.

In another embodiment, a branch bank computer is used as an interface between user computers and a drawing number server. The branch bank computer requests and receives blocks of drawing numbers from the drawing number server. A user on a user computer transmits a request to a branch bank computer, which will issue a drawing number to the user if one is still available. If the block of drawing numbers at the branch bank computer is depleted, the branch bank computer will request a new block of drawing numbers from the drawing number server.

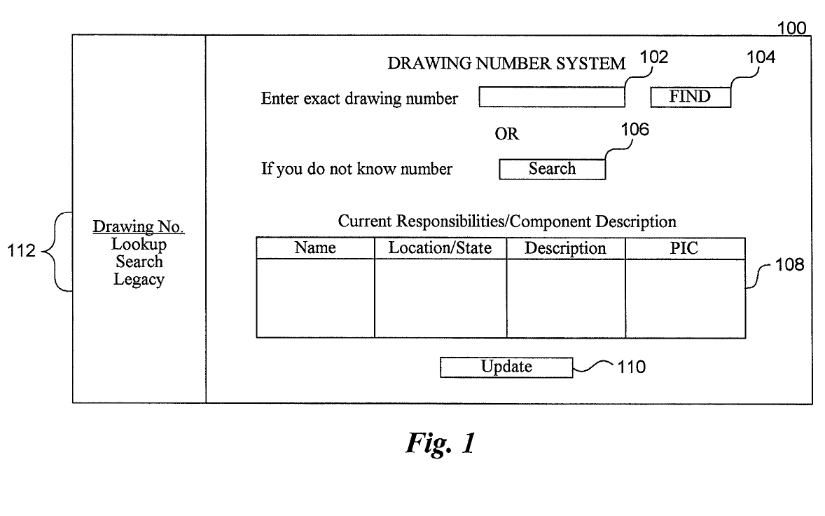

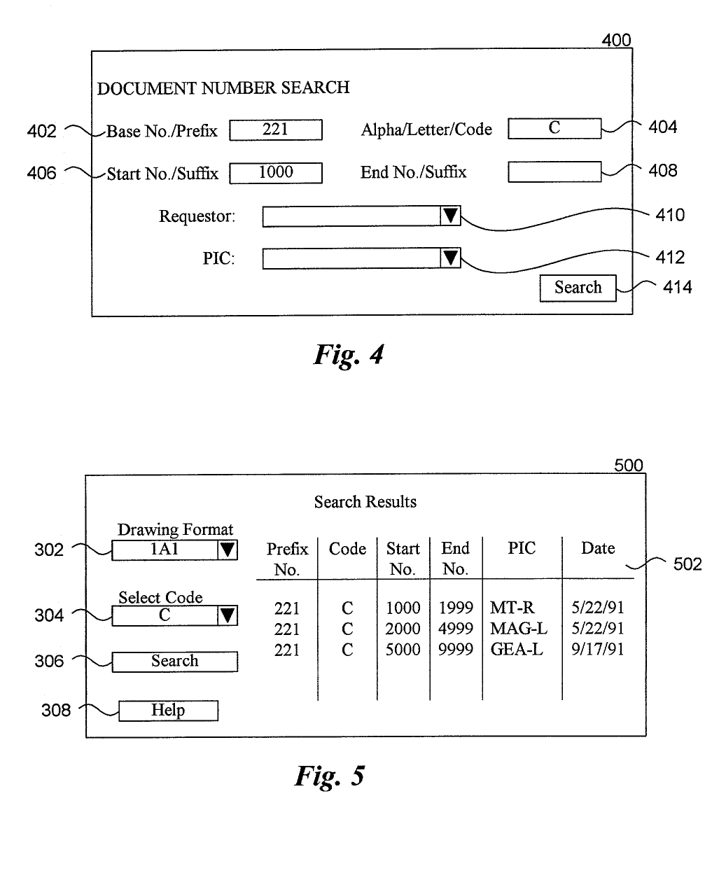

FIGS. 1-13 are web pages that illustrate the user interface of the drawing number system in one embodiment. FIG. 1 illustrates the main menu of the drawing number system. Web page 100 includes an exact drawing number field 102 and a find button 104. If the user knows the exact drawing number, this number can be entered in the exact drawing number field 102. After entering the drawing number, selecting the find button 104 will start the process of retrieving and displaying information about the exact drawing number entered. Web page 100 also includes a search button 106, which can be selected by a user to search for a drawing number by activating a pop-up search web page 400 that accepts user input. The pop-up search web page 400 is described in reference to FIG. 4.

Web page 100 also includes a results box 108 that displays the results of an exact number search or other search. In one embodiment, the results box 108 contains four vertical columns of information for display: name, location/state, description, and PIC. Name is usually the full name of the organization identified by the PIC. The location/state column identifies the geographic location of the personnel responsible for the drawing number. The description column can be used for any type of text description, including a description of the item depicted in the drawing. The PIC column is used to identify the product identification code (“PIC”), which is a code used to uniquely identify the organization with responsibility for a drawing. For example, a four-letter code may be used to identify an organization (e.g., TBO-S for Turbine Business Operations—Schenectady), and a four-number code may be used to identify an outside supplier. The results box 108 also can show history associated with a drawing number. For example, if the PIC associated with a drawing number changes over time, each PIC may be identified in the results box 108 as a separate line entry, with the current PIC on top.

Web page 100 also includes an update button 110 that a user can select to update the information for the drawing number. For example, the user can request that the responsible organization be changed for a drawing number. Menu 112 includes a lookup menu item, a search menu item, and a legacy menu item. The lookup menu item is selected when the drawing number is known and other information about the number, such as other information about the responsible organization, is desired. The search menu item is selected when only part of a drawing number is known. The search returns all possible drawing numbers that match the search criteria entered by a user. The legacy menu item is selected when the user desires to search some types of drawing number formats no longer active in the company. In one embodiment, some types of legacy drawing number formats are stored in a Microsoft Excel file, and selecting the legacy menu item calls up an interface for interacting with the Microsoft Excel file.

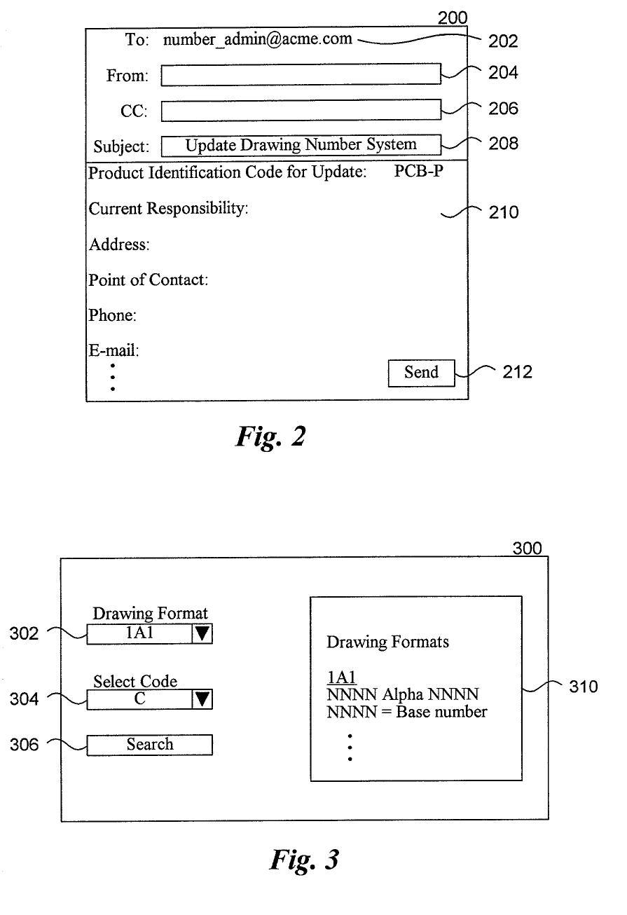

FIG. 2 illustrates an update web page 200, which is displayed when the user selects the update button 110. Web page 200 allows a user to send updated information about a drawing number to a drawing number administrator who can decide whether to actually update the information in the drawing number database. Web page 200 includes a recipient address field 202, a sender address field 204, a cc address field 206, a subject field 208, a data entry field 210, and a send button 212. The recipient address field 202 may be coded so that all update requests are sent to the same recipient. The sender address field 204 allows the user to specify a return e-mail address, in the event that the administrator has any questions or wishes to send confirmation of the update. The cc address field 206 is similarly used to allow the user to specify additional e-mail addresses to send the update request. The subject field 208 allows the user to input a subject or title of the update request. In one embodiment, the information could be automatically inserted into the sender address field 204, the cc address field 206, or the subject field 208. The data entry field 210 allows the user to write a text description of the updated information. The user selects the send button 212 to send the update request. For example, the user could enter updated contact information for a particular PIC or the user could enter information about the PIC of an organization that has taken over responsibility for the drawing number. The administrator could then make any necessary changes to the databases of the drawing number management as appropriate, or could request more information from the user.

FIG. 3 illustrates a search web page 300, which is displayed when the user selects the search menu item in the menu 112. The search menu item is generally selected when only part of a drawing number is known by the user (e.g., only a prefix or only a suffix). Web page 300 includes a drawing format selector 302. The drawing format selector 302 allows the user to select the drawing format for which the user wishes to search, which will ultimately result in a search of the corresponding section of a drawing number database. In one embodiment, one drawing number format is “1A1,” which includes a four-number prefix, one letter, and a four-number suffix (“NNNNANNNN”, where N is a number and A is a letter). Other drawing number formats are described below.

Web page 300 also optionally includes a select code selector 304, which allows the user to specify a letter in the drawing number. In one embodiment, the select code selector 304 is only used when drawing format “1A1” is selected with selector 302. In this situation, selector 304 is used to select the middle letter of the drawing number. In one embodiment, the letters ‘O’ and ‘I’ are unavailable because of their visual similarity to numbers. This allows the user, for example, to conduct a search for drawing numbers containing the selected letter, which could be associated with a type of drawing, a size of drawing, or an organization. Web page 300 also includes a search button 306 for displaying the search results.

FIG. 4 illustrates the document number search web page 400, which is displayed when the search button 306 is selected. Web page 400 includes a prefix field 402 that allows a user to input the prefix, if known, for the search. For example, if “221” was input into the prefix field 402, the search would only return drawing numbers with a prefix of 221. Web page 400 includes a letter field 404, which allows a user to input the letter for a drawing number search. In one embodiment, the letter for use in searching is selected using web page 300 and the letter field 404 is display only. If display only, the letter in the letter field 404 is usually grayed-out or provided with some other visual indication that the letter cannot be changed.

Web page 400 also includes a start suffix number field 406 and an end suffix number field 408 that allows a user to specify a start suffix number and an end suffix number, respectively. When specified, the search returns all drawing numbers within that range of suffix numbers. Web page 400 includes a requestor selector 410 and a PIC selector 412. The requester selector 410 allows the user to specify that the search is to be limited to those drawing numbers requested by the specified requester. The PIC selector 412 allows the user to select a PIC to further refine a search. For example, the user could search for drawing numbers associated only with a certain organization in the company. A search button 414 is also included in web page 400 to start the search.

FIG. 5 shows the search results web page 500. Web page 500 includes the drawing format selector 302, select code selector 304, search button 306. Web page 500 also includes the results display 502, which shows the results of the search. In one embodiment, the results display 502 has a number of columns of information, including prefix number, letter code, start suffix number, end suffix number, PIC, and date. A sample search criteria is depicted in FIGS. 3-5, and the corresponding sample results are shown in the results display 502. The search criteria indicates that the drawing format is “1A1”, the letter code is C, the prefix number is 221, and the start suffix number is 1000, while the end number suffix, requester, and PIC are left blank. As can be seen in the results display 502, three rows of information indicating blocks of drawing numbers are displayed, with the lowest suffix corresponding to the start suffix and the highest suffix being the highest possible suffix. First, a block of drawing numbers from 221C1000 to 221C1999 is indicated. For this block, the PIC, and responsible organization, is “MT-R” and the block was issued to MT-R on May 22, 1991. Similarly, the block 221C2000-221C4999 is shown as being issued to MAG-L on May 22, 1991, and the block 221C5000-221C9999 is shown as being issued to GEA-L on Sep. 17, 1991. One skilled in the art will recognize that other alternatives are possible, including different combinations of search criteria. For example, when the search criteria specifies only a letter and a PIC, the result includes all blocks of drawing numbers with that letter that are assigned to that PIC. In another example, when the search criteria specifies both the start suffix number and end suffix number, only drawing number of blocks with suffixes between the start and end suffix numbers are displayed.

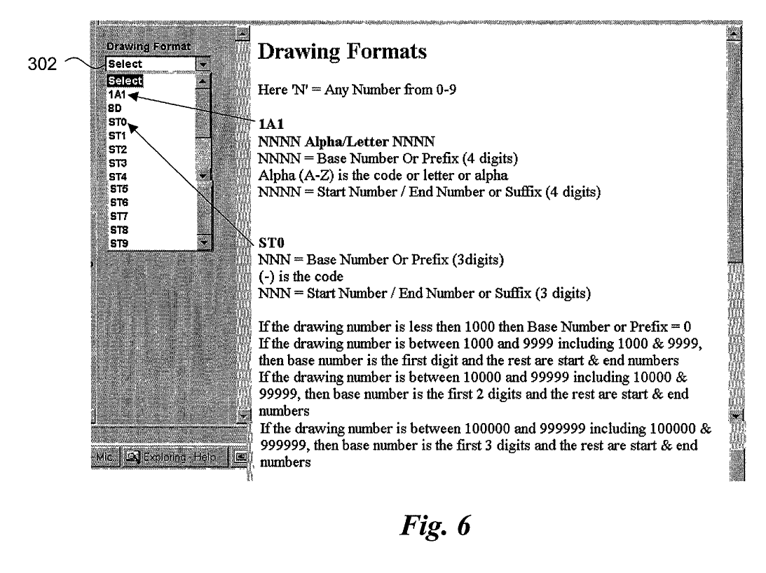

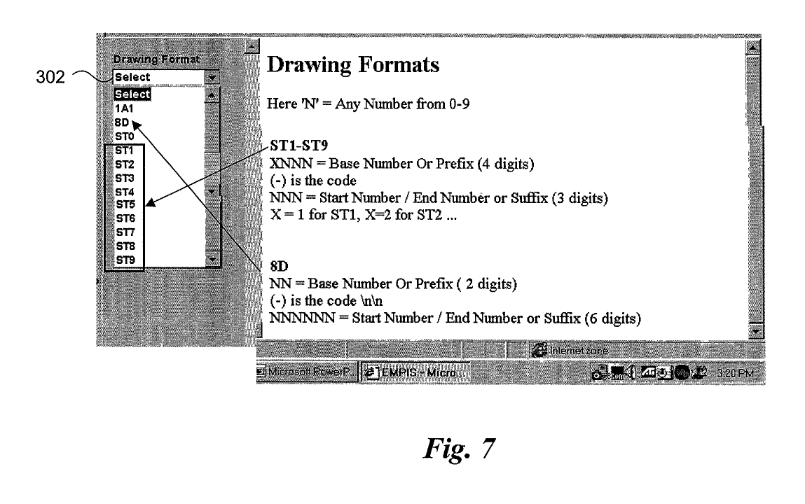

FIGS. 6-7 show different drawing formats that can be selected by the user using the drawing format selector 302. When one of the drawing number formats is selected (1A1, 8D, ST1, etc.), the other input fields on the search web page 300 and the document number search web page 400 are modified accordingly. For example, if ST1 format is selected via selector 302, the letter in the letter field 404 is automatically a hyphen (“-”) and the hyphen is automatically input into the letter field 404. In another example, if format 8D is selected, the prefix number can only be two digits, and the prefix field 406 is modified accordingly.

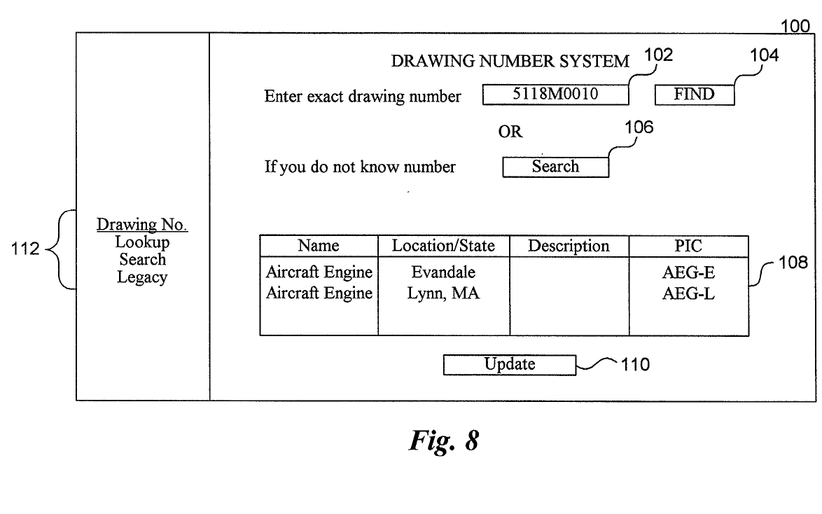

FIG. 8 shows the result when the exact drawing number is input by a user. In FIG. 8, an exact drawing number is input into the exact drawing number field 102. When the find button 104 is selected, the results of the search are displayed in the results box 108. An example search result is depicted in FIG. 8, with two rows of data in the results box 108. From the results box 108, it can be seen that the drawing depicts an aircraft engine and that the organization with authority over the drawing number is identified with AEG-E (Aircraft Engines, Evendale), and that the organization is based in Evendale. It can also be seen that an organization identified by AEG-L (Aircraft Engines, Lynn), and located in Lynn, previously had responsibility for the drawing. If the user thinks the information is incorrect, they can select the update button 110 and send an update message to an administrator for review.

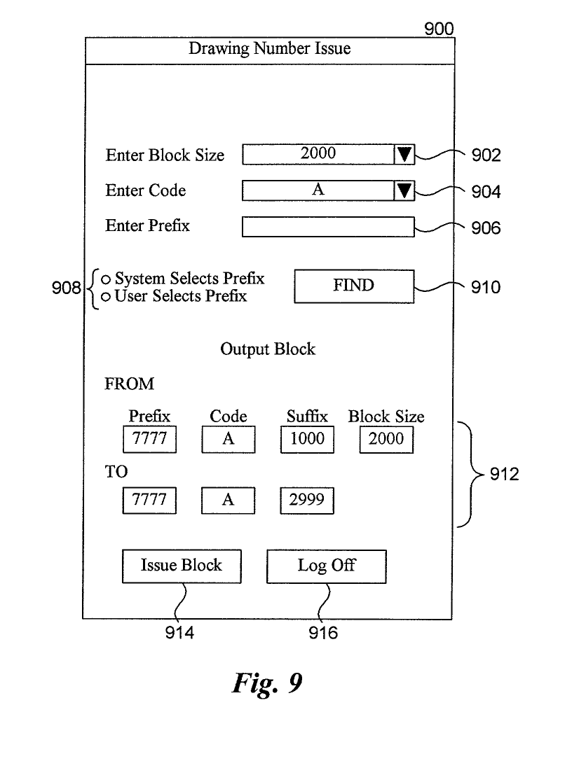

FIG. 9 depicts an issue web page 900. In order for a user to get to the issue web page 900, the user logs on to the system with a user name and password. Security methods such as passwords are well known in the art. The issue web page 900 allows a user (i.e., a requester) to request and automatically receive a new block of drawing numbers. The block of drawing numbers can then be distributed to draftspersons throughout the user's organization. In previous systems, the user would have to manually request a block of numbers from a human administrator, who would have to determine the next available block of numbers. In this embodiment, only drawing numbers in a 1A1 format are available. This is an improvement over book-based systems, as the need for an administrator to manually issue blocks of drawing numbers is eliminated.

The issue web page 900 includes a block size selector 902 that allows a user to specify the size of the block of drawing numbers to be issued. In one embodiment, a user can specify a size of 2000, 5000, or 9000 numbers in the block. The issue web page 900 also includes a code selector 904 that allows a user to select the code (e.g. letter) associated with the drawing number block. In other words, when a user selects a particular code, then all drawing numbers issued will have that code in the drawing number.

The issue web page 900 further includes a prefix field 906 and a prefix radio button 908. The prefix field 906 is optional, and allows the user to input a starting prefix field if desired. For example, the user could input 7777 as a prefix, and the system would attempt to give the user the earliest block of numbers available with that prefix. Alternatively, the user could allow the system to pick the next available block of drawing numbers by selecting the appropriate setting of the prefix radio button 908. When the user is ready to request the block of drawing numbers, the user selects find button 910.

The issue web page 900 also includes an output block 912, which displays the block of numbers that is found. In one embodiment, the output block 912 displays the first number and last number in the block, including the prefixes, codes, and suffixes. The output block 912 also displays the block size for reference. If the user is satisfied with the found block of drawing numbers, the user selects the issue block button 914 to issue the block. Alternatively, the user could select the log off button 916 and exit the system without issuing the block.

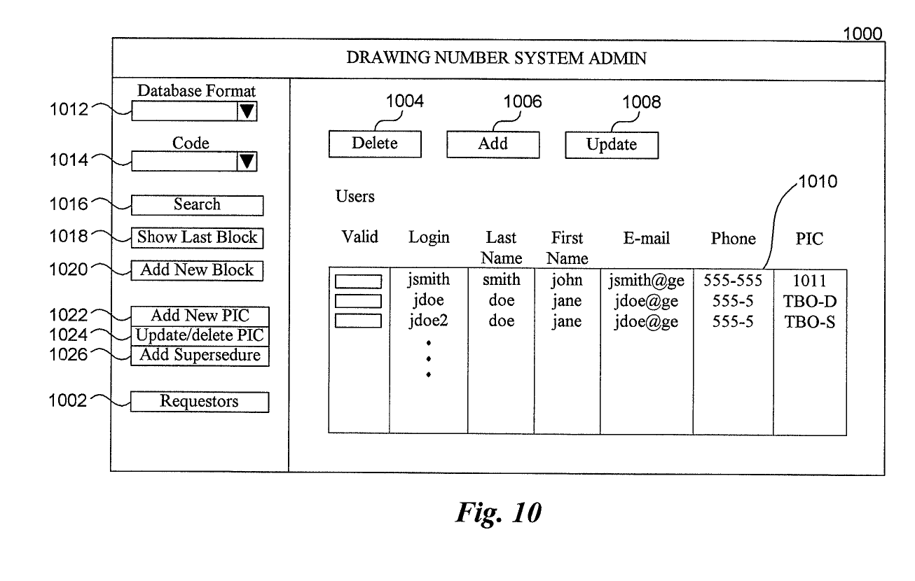

FIGS. 10-13 illustrate administrative functions of the system in one embodiment. FIG. 10 illustrates the admin web page 1000. The admin web page 1000 is the primary page that an administrator of the drawing number system uses to perform administrative tasks such as adding new users, updating PICs, etc. The admin web page 1000 includes a requesters button 1002 in the left frame which allows the administrator to update requesters information. When the administrator selects requesters button 1002, the system displays information about requesters in the right frame. A requester is a person authorized to use the drawing number system to issue blocks of drawing numbers on behalf of the requestor's organization. The requester list 1010 displays a list of the requesters. In one embodiment, the system allows only one PIC to be assigned to a requester. If a person is a requester for more than one PIC, then that person would have two requester entries with different logon names. The requester list shows information about each requester, including the logon name, last and first name of the individual, e-mail address, and phone number and possibly the PIC for that PIC entry. The logon name is the requester name, and it can be seen from FIG. 10 that one person (Jane Doe) has multiple logon names and thus issued multiple PICs.

The admin web page 1000 also includes a delete button 1004, an add button 1006, and an update button 1008. The add button 1004 is used to add a requester, the update button 1008 is used to edit the settings for a requestor, and the delete button 1004 is used to delete a requester.

The database format selector 1012, the letter selector 1012, and the search button 1016 on the admin web page 1000 are used to provide the search functions described in relation to FIGS. 3-5 to the administrator. The show last block button 1018 displays the last block issued to a requester in either a pop-up window or in the right frame. The add new block button 1020 displays the web page 900 depicted in FIG. 9. Admin web page 1000 also includes an add new PIC button 1022, an update/delete PIC button 1024, and a supersede button 1026. These buttons are used to add a new PIC, edit an existing PIC, or make global changes to the PIC assigned to components

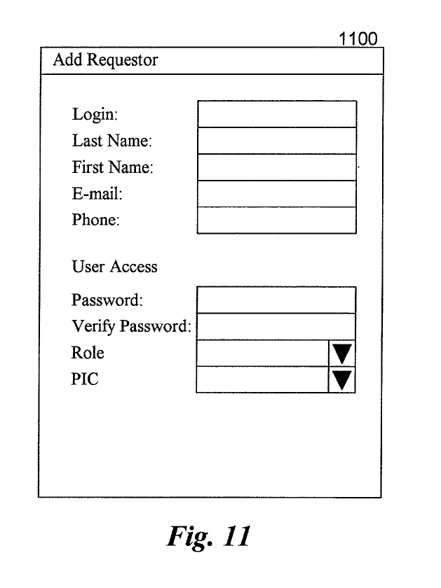

FIG. 11 illustrates the add requestor web page 1100. The add requester web page 1100 contains information that the administrator may input about a new requester to be added to the system. A logon name can be either entered manually or automatically generated. Personal information about the new requester can also be input, such as first and last names, e-mail address, and phone number. The administrator can also input a password (and verification) for the new requester. The add requester web page 1100 also contains a role selector to allow the administrator to define the permissions on the drawing number system that the new requester will have, and a PIC selector to allow the administrator to specify the PIC for which the requester can request blocks of drawing numbers.

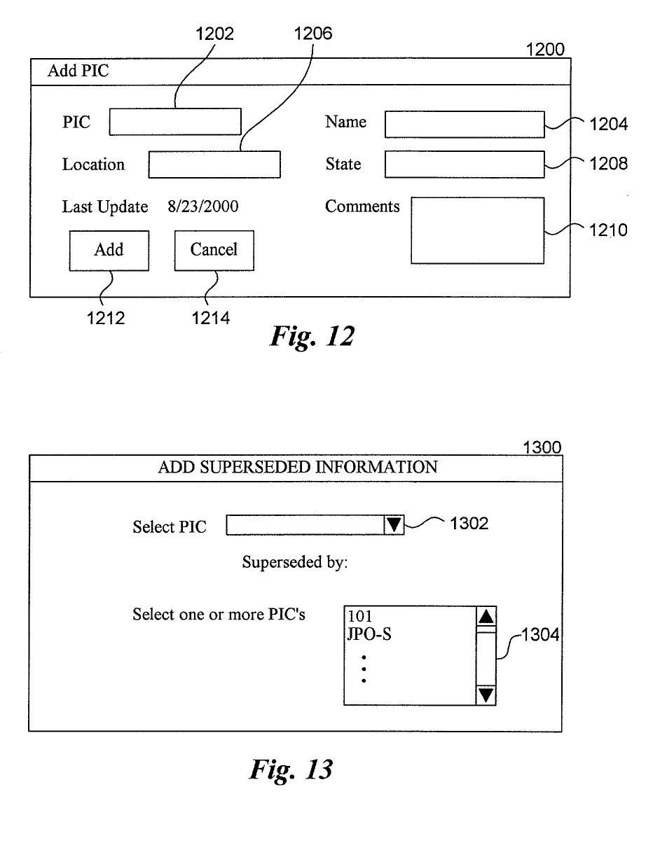

FIG. 12 illustrates the add PIC web page 1200 which is used to add a new PIC to the drawing number system. Web page 1200 includes a PIC field 1202, a name field 1204, a location field 1206, a state field 1208, and a comment field 1210. The PIC field 1202 is used in input the code for the new PIC. The name field 1204 contains the full name for the new PIC and the location field 1206 and state field 1208 contain information about where the organization associated with the PIC is located. The comments field 1210 can be used for any comments or other text about the new PIC, such as history, important information, or contact personnel. Web page 1200 also contains an add button 1212, which is used to add the new PIC information to the system, and a cancel button 1214, which is used to cancel the add operation without adding the new PIC.

FIG. 13 illustrates the supersede web page 1300. The supersede web page 1300 is used to make global changes to all of the drawing numbers associated with a particular PIC. Web page 1300 includes a select PIC selector 1302, which provides a list of all active PICs for selection by the user. After the user selects a PIC to be superseded, the user selects a PIC using the PIC input 1304. This function is particularly useful when one organization transfers control of all its drawing numbers to another organization, whether by sale, acquisition, change in responsibilities, or any other reason. Using web page 1300, all drawing numbers assigned to the selected PIC have the new PIC added to their list of PICs. In this way, when a user selects one of those drawing numbers, the new PIC is indicated as the responsible organization. This prevents an administrator from having to manually change the PICs for a large number of drawing numbers when organization control changes.

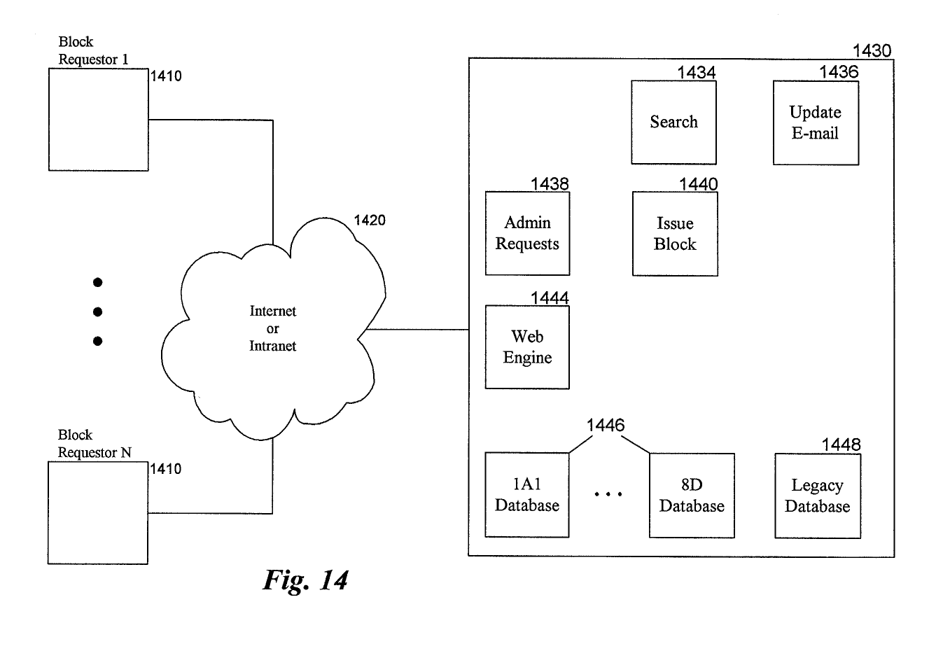

FIG. 14 is a block diagram illustrating components used to implement the drawing number system in one embodiment. The block requester computers 1410 and the drawing number server computer 1430 are interconnected via a computer network 1420, such as the Internet or an intranet. The computers may include a central processing unit, memory, input devices (e.g., keyboard and pointing devices), output devices (e.g., display devices), and storage devices (e.g., disk drives). The memory and storage devices are computer-readable media that may contain instructions that implement the document management system. In addition, the data structures and message structures may be stored or transmitted via a data transmission medium, such as a signal on a communications link. Various communications channels other than the Internet or an intranet may be used, such as a local area network, a wide area network, or a point-to-point dial-up connection. The drawing number server 1430 includes a search component 1434, an update component 1436, an admin request component 1438, an issue block component 1440, a web engine 1444, databases 1446, and a legacy database component 1448. The search component 1434 receives a search criteria (which may be an exact number), performs a search of the databases, and displays information for the drawing numbers that match the search criteria. The update component 1436 is used to accept and process update requests by users, usually provided via e-mail. The admin requests component 1438 includes the administration modules such as modules to add, edit, or delete requesters and PICs. An access sub-component of the admin request component 1438 allows an administrator to define permissions for requesters. The admin requests component also includes a sub-component to handle supersede requests. The issue block component 1440 receives a request for a block of drawing numbers and issues the next available block or numbers consistent with the request. The issue block component 1440 includes both a selection sub-component for selecting an unissued block of drawing numbers and an issuing sub-component for actually issuing the selected block of drawing numbers. The web engine 1444 receives HTTP requests and coordinates the sending of the HTTP response messages corresponding to the displays of the drawing number system.

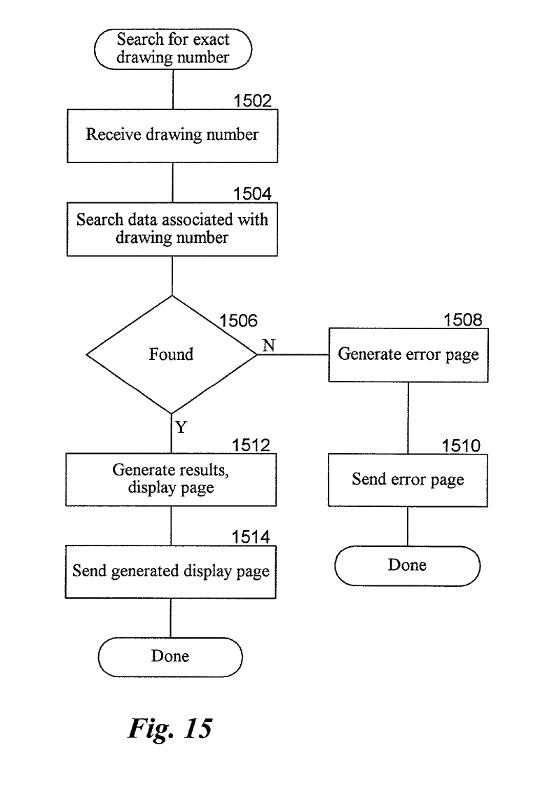

FIGS. 15-19 are flow diagrams illustrating aspects of the processing of the drawing number system. FIG. 15 is a flow diagram illustrating the processing of a selection of an exact drawing number search. The web engine invokes this function when it receives an indication that the user requested an exact drawing number search. In block 1502, the function receives a drawing number. In block 1504, the function searches the appropriate database associated with the drawing number format for information about the drawing number. In this embodiment, each format of drawing number is stored in a different database, but other alternatives are possible. In decision block 1506, if no information is found about the drawing number, then the function continues at blocks 1508, else the function continues at 1512. In block 1508, the function generates an error page, and in block 1510, the function sends the error page to the user for display and then completes. In block 1512, the function generates a results display page, and in block 1514, the function sends the generated display page to the user for display.

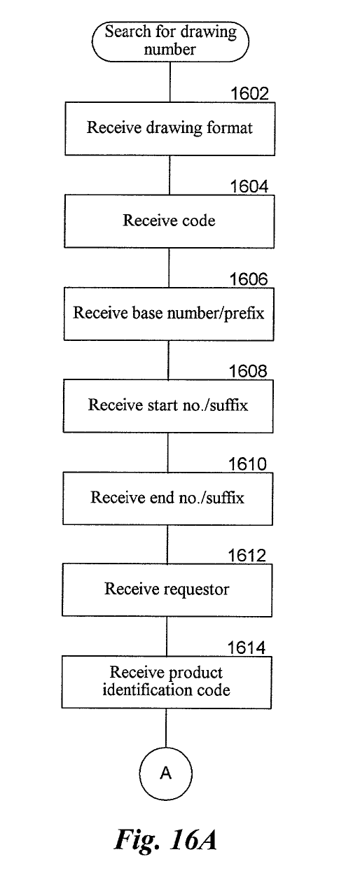

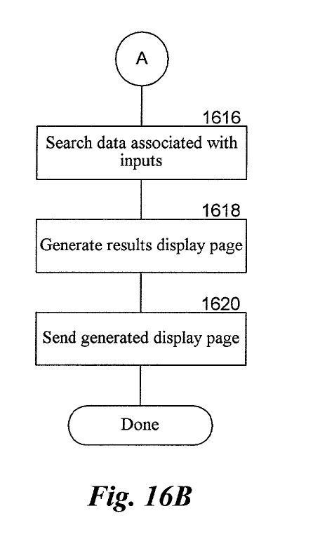

FIGS. 16A-16B are flow diagrams illustrating the search for drawing number information when the exact drawing number is not known. The server engine invokes this function when it receives an indication that the user has selected to perform a search. In block 1602, the function receives the drawing format, which can be any type of supported format. In block 1602, the function determines whether some of the later steps can be skipped based on the format of the drawing number. For example, if the format does not require a prefix, then block 1606 could be skipped. In block 1604, the function receives the code. In the case of 1A1 format, the code is a letter, but other alternatives are possible. In block 1606, the function receives the base number or prefix for the drawing number. In blocks 1608 and 1610, the function receives the starting suffix number and the ending suffix number. In block 1612, the function receives the requestor name. In block 1614, the function receives the PIC. In block 1616, the function searches a database to find records of drawing numbers that match the search criteria inputs received in blocks 1602 through 1614. Each drawing format could be stored in a different database or different drawing formats could be combined in the same database. In block 1618, the function generates a results display page. In block 1620, the function sends the generated display page to the user for display.

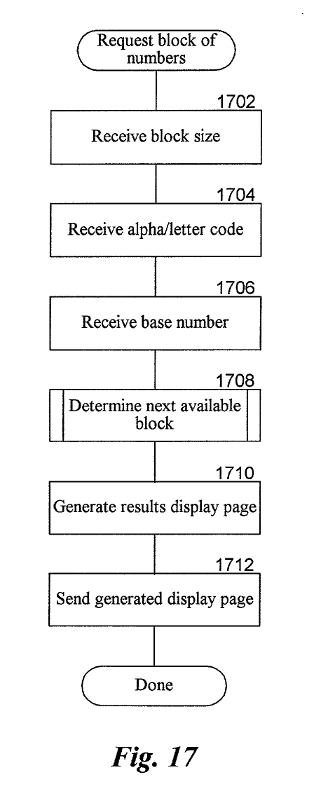

FIG. 17 is a flow diagram illustrating the processing of a request for a block of new drawing numbers to be issued to a requester. The server engine invokes this function when it receives an indication to issue a block of drawing numbers to a requester. In one embodiment, all new drawing numbers, and thus all new drawing number blocks, are in 1A1 format. In block 1702, the function receives the desired block size from the requestor. In block 1704, the function receives the desired code from the requester. In block 1706, the function receives a base number from the requestor. Blocks 1702, 1704, and 1706 are all optional, and default values can be used in the event that the requester does not provide the information. In block 1708, the function invokes a function to determine the next available block of drawing numbers. In block 1710, the function generates a results display page. In block 1712, the function sends the generated display page to the user for display.

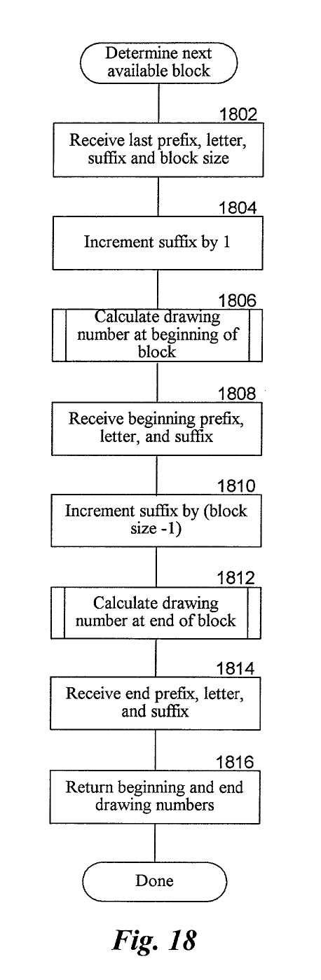

FIG. 18 is a flow diagram illustrating the processing of a request for determining the next available block of drawing numbers. In block 1802, the function receives the prefix, letter, and suffix of the last drawing number issued. This information is stored in a database in one embodiment. In block 1804, the function increments the suffix by one (1). In block 1806, the function invokes a function to calculate the beginning drawing number. That function calculates the drawing number for the beginning of the block. In block 1808, the function receives the beginning prefix, code, and suffix from the invoked function. In block 1810, the beginning suffix is incremented by the block size minus one (block size−1). In block 1812, the function again invokes a function to calculate the drawing number at the end of the block. In block 1814, the function receives the end prefix, code, and suffix from the invoked function. In block 1816, the function returns the beginning and end drawing numbers of the new block. In this embodiment, if a block is too large for the available suffix numbers, then the issued numbers wrap to the next prefix number or code as appropriate. The system alternatively only assigns blocks as sequential suffix numbers without allowing wrapping to the next prefix number or letter.

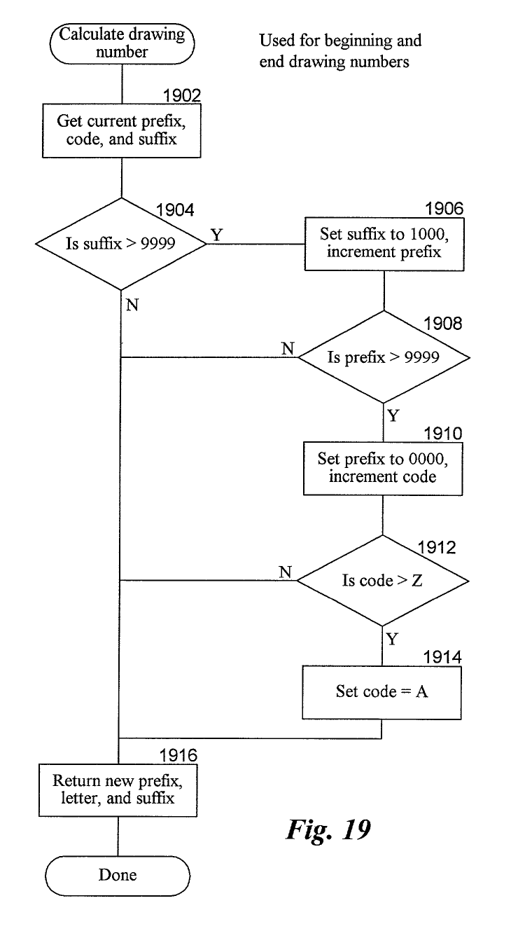

FIG. 19 is a flow diagram illustrating the processing of a request to calculate a drawing number. In block 1902, the function receives the current prefix, code, and suffix of the drawing number. In decision block 1904, if the suffix is greater than 9,999, then the function continues at block 1906, else the function continues at block 1916. In block 1906, the function sets the suffix to 1000 and increments the prefix. In decision block 1908, if the prefix is greater than 9,999, then the function continues to block 1910, else the function continues at block 1916. In block 1910, the function sets the prefix to 0 and increments the current code by one (e.g., ‘A’ becomes ‘B’). In decision block 1912, if the code is greater than ‘Z,’ then the function continues at block 1914, else the function continues at block 1916. In block 1914, the function sets the code to ‘A.’ In block 1916, function returns the new prefix, letter, and suffix to the invoking function.

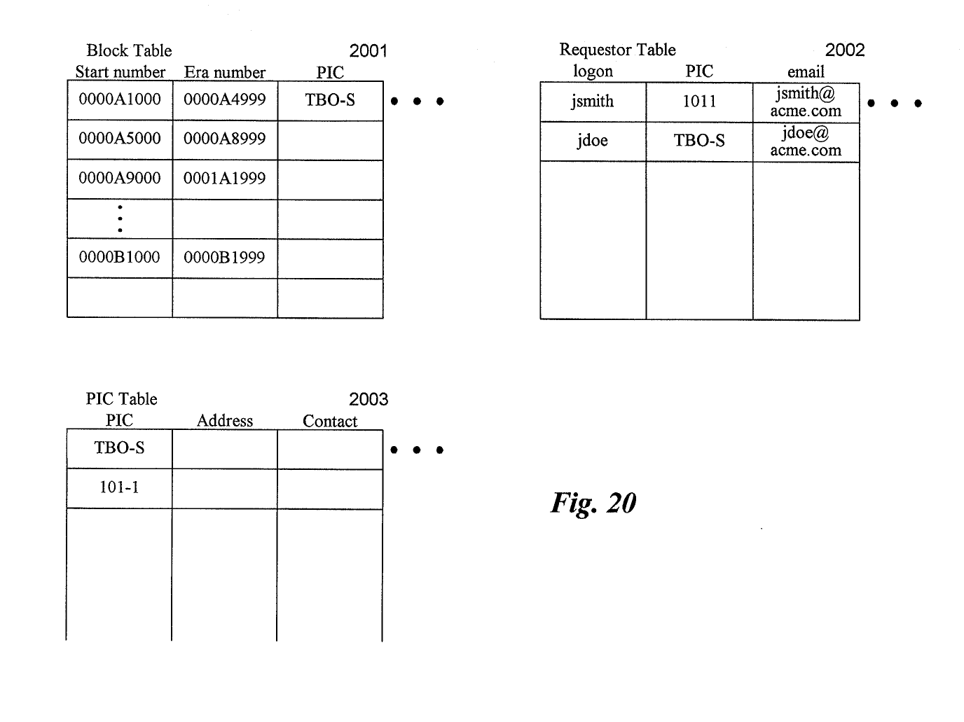

FIG. 20 is a block diagram illustrating data structures of a sample database in one embodiment. The database includes a block table 2001, a requestor table 2002, and a PIC table 2003. These tables represent a logical organization of the data. One skilled in the art would appreciate that varying physical organizations of the data may be used. The block table contains an entry for each a block that has been issued. The first entry of the block table indicates that the block starting with number 0000A1000 and ending with number 0000A4999 is currently assigned to the PIC identified by TBO-S. The ellipsis indicates that the block table may have more columns of information such as the logon of the original requester and issue date. The block table may have an associated auxiliary table which contains a complete history of the PICs that have had responsibility for each block of numbers. The requester table contains an entry for each requestor who has been registered. The first entry indicates that the requester with a logon of “jsmith” is associated with the PIC of “1011.” The ellipsis indicates that the requester table may have more columns of information such as the name of the requester. The PIC table contains an entry for each PIC that has been registered. The first entry indicates that the PIC of “TBO-S” has been registered. The ellipsis indicates that the PIC table may contain additional information about each PIC.

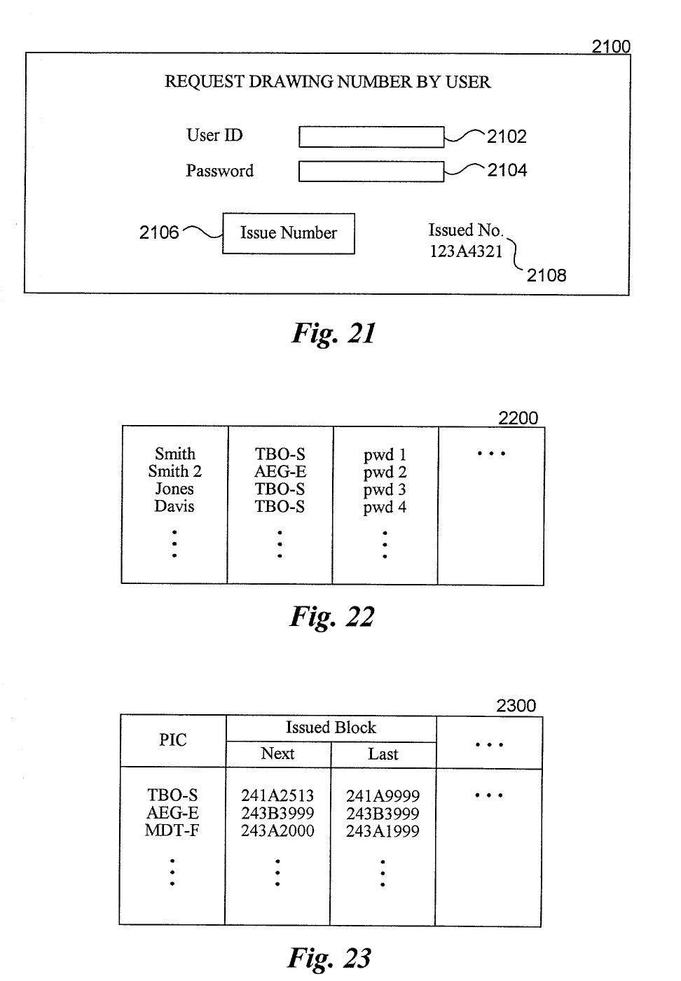

FIGS. 21-27 describe alternative embodiments of the drawing number system where a number requester can request an individual drawing number whenever needed. These alternative embodiments eliminate the need for a person (e.g. a requester) to manually request a block of drawing numbers for a particular PIC. Instead, the system can issue individual drawing numbers directly to number requesters based on the PIC associated with each number requester, and can automatically issue another block of drawing numbers to a particular PIC whenever necessary.

FIG. 21 is a web page that illustrates the user interface of the drawing number system in one embodiment. Web page 2100 includes a user identification field 2102 and a password field 2104. The user identification field is used by the number requester to input a unique user identification. The user identification typically represents one number requester, and a separate number requestor database (described in relation to FIG. 22) contains information associated with each user identification. The password field is used to enter a password to authenticate the user entering the particular user identification. Web page 2100 also includes an issue number button 2106 that allows for a user to request a new drawing number after the user identification and password have been input by the number requester. The results of the drawing number request are displayed in the results box 2108, which will typically contain the new drawing number issued to the user after processing is complete.

FIG. 22 illustrates the data structure of a user database 2200 in one embodiment. In this embodiment, the user identifications may be stored in a left-hand column of the user database 2200 and typically represents one individual user. Accordingly, each user identification should be unique. Each user identification may also have associated with it a PIC that represents the organization from which the user may request drawing number. In this embodiment, the PIC may be stored in a central column. Because each PIC is issued blocks of drawing numbers in this embodiment, the PIC can be used to determine which drawing number (and thus which issued block of drawing numbers) should be assigned to a particular user identification when a request is made by a user. Since each user identification only has one PIC associated with it in this embodiment, a user that needs permissions for multiple PICs should have multiple user identifications (e.g., Smith and Smith2 in FIG. 22). The user database may also contain a password for each number requester stored in a right-hand column. The passwords are used for authentication of each number requester. The ellipsis indicates that the user database may contain additional information about each user. The user database may be accessed by the drawing number repository and one or more of the branch bank computers.

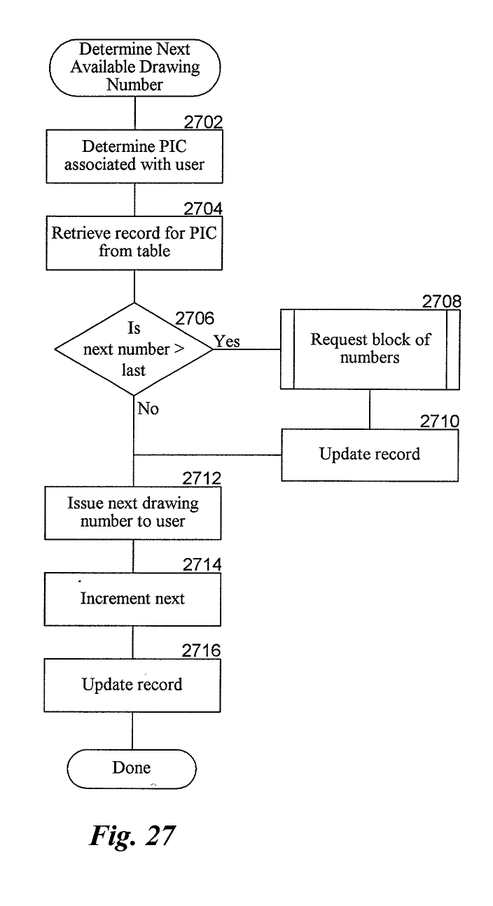

FIG. 23 illustrates the data structure of an issued block database 2300 in one embodiment. The issued block database 2300 contains information about each PIC and last drawing number block issued to each PIC. In this embodiment, a list of PICs is contained in a left-hand column of the issued block database 2300. In a center column, the next available drawing number may be stored for each PIC. Additionally, the last drawing number issued within a block may be stored in a right-hand column. When a block of drawing numbers is first issued to a particular PIC, the first number in the block may be stored in the next drawing number column and the last number in the block may be stored in the last drawing number column. As described in detail in relation to FIG. 27, the next drawing number is typically incremented by one each time a drawing number is issued until the end of the drawing block is reached. The ellipsis indicates that the issued block database may contain additional information about each issued block of drawing numbers.

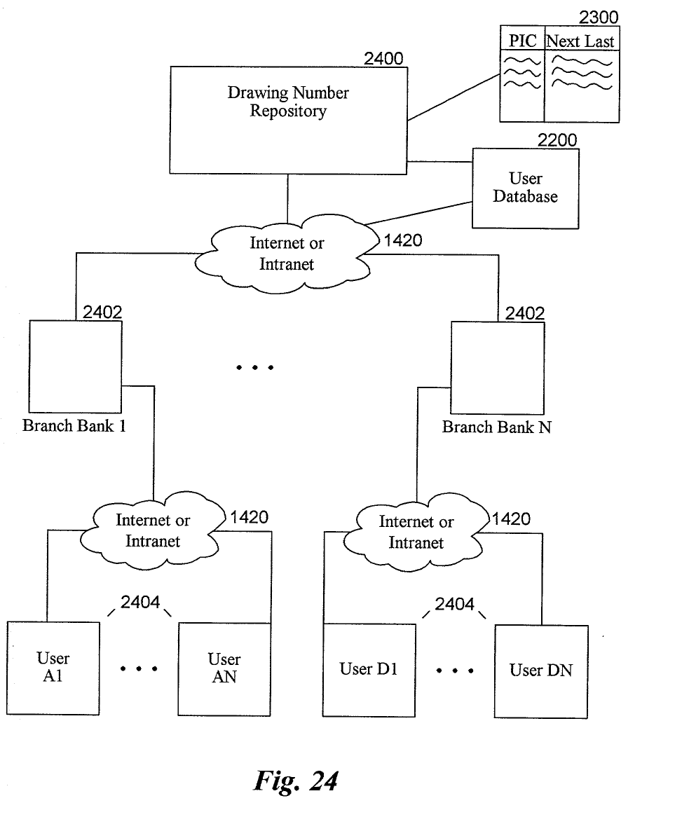

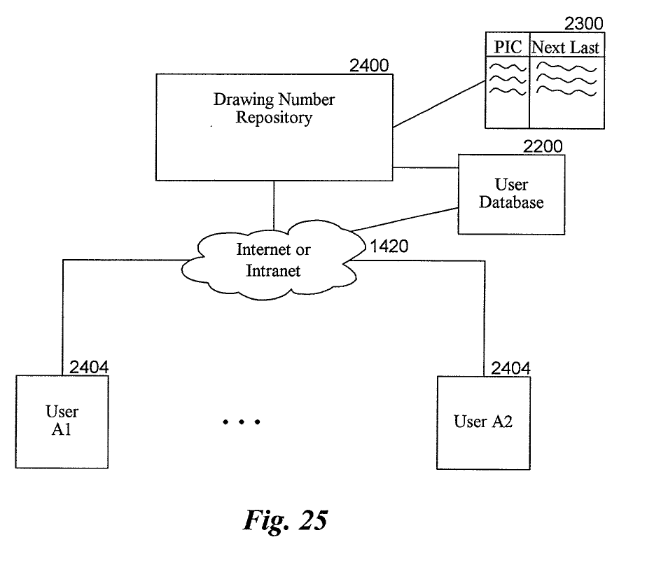

FIGS. 24-25 are block diagrams illustrating components used to implement the drawing number system in some embodiments. FIG. 24 illustrates the components used in one branch bank embodiment of the drawing number system. A drawing number repository 2400 provides the system functions for the drawing number system, and may be substantially similar to the drawing number server computer 1430 described in relation to FIG. 14. The drawing number repository may be connected to or contain a user database. The drawing number repository also may be connected to or contain an issued block database. The drawing number repository and one or more branch bank computers 2402 are interconnected via a computer network 1420, such as the Internet or an intranet. The computers may include a central processing unit, memory, input devices (e.g., keyboard and pointing devices), output devices (e.g., display devices), and storage devices (e.g., disk drives). The memory and storage devices are computer-readable media that may contain instructions that implement the document management system. In addition, the data structures and message structures may be stored or transmitted via a data transmission medium, such as a signal on a communications link. Various communications channels other than the Internet or an intranet may be used, such as a local area network, a wide area network, or a point-to-point dial-up connection. Similarly, each branch bank computer may be interconnected to one or more user computers 2404 via a computer network. Each branch bank computer may be associated with one or more PICs and can used to request and receive blocks of drawing numbers from the drawing number repository. The user computers can be used by users to request individual drawing numbers from a branch bank computer. When a block of drawing numbers is depleted after multiple requests from user computers, the branch bank may request a new block of drawing numbers from the drawing number repository.

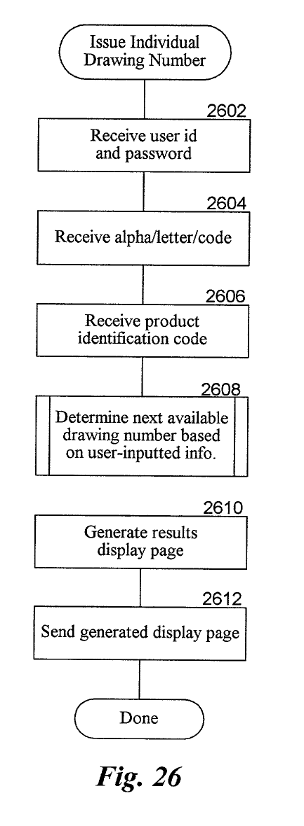

FIG. 25 illustrates the components used in another embodiment of the drawing number system. A drawing number repository can be connected to or contain a number requester database. The drawing number repository also may be connected to or contain an issued block database. The drawing number repository and one or more user computers also may be interconnected via a computer network, such as the Internet or an intranet. The user computers may be used by individual users to request drawing numbers from the drawing number repository. The drawing number repository may issue a drawing number to an authorized user on a user computer based on the routines described in FIGS. 26-27.

FIGS. 26-28 are flow diagrams illustrating aspects of the processing of the drawing number system. FIG. 26 is a flow diagram illustrating the processing of a request from a user for a new drawing number. The server engine within the drawing number repository invokes this function when a request for an individual drawing number is received from a user. In block 2602, the function receives a user identification and a password from the user. In block 2604, the function receives the code (e.g., letter) from the user. This block is optional and only need be performed if the user desires to receive the next drawing number with a particular code instead of receiving the next drawing number of any code. In block 2606, the function receives a PIC associated with the user to determine which block of drawing numbers from which to select the new drawing number. In this embodiment, the function accesses the user database to determine the PIC associated with a particular user identification. Alternatively, the PIC could be received directly from the user. The function continues in block 2608, where the function accesses the function described in FIG. 27 to determine the next available drawing number based on user-inputted information. In block 2610, the function generates a results display page based on the drawing number returned by the function. In block 2612, the function can send the generated display page for display to a user. The results box 2108 described in relation to FIG. 21 is one embodiment of a display of a newly issued drawing number to a user.

FIG. 27 is a flow diagram illustrating the processing of a function to determine the next available drawing number in an issued block of drawing numbers. In block 2702, the function may determine the PIC associated with the user identification. In this embodiment, the function accesses the user database to determine the PIC associated with the inputted user identification. In block 2704, the function accesses the issued block database to search for information about the most recent block of drawing numbers issued for that particular PIC. In one embodiment, both the next drawing number and the last drawing number issued are accessed from the issued block database 2300. The last drawing number is simply the last drawing number that was issued from that block of drawing numbers. The next drawing number is the last drawing number plus one (an increment of one).

In decision block 2706, the next drawing number and the last drawing number are compared. If the next drawing number is larger than the last drawing number, then the function continues at block 2708 by requesting a new block of drawing numbers (as described in relation to FIG. 17). After receiving the new block of drawing numbers, the function continues to block 2710, where the issued block database is updated to reflect the new drawing number block. In this embodiment, the first drawing number in the block becomes the next drawing number and the last drawing number in the block becomes the last drawing number. After issued block database is updated, the function continues to block 2712. If the next drawing number is not larger than the last drawing number, the function simply continues to block 2712.

In block 2712, the next drawing number is transmitted to the user on a user computer for display. The function continues in block 2714, where the next drawing number is incremented by one. Finally, the issued number database is updated to reflect the updated next drawing number.

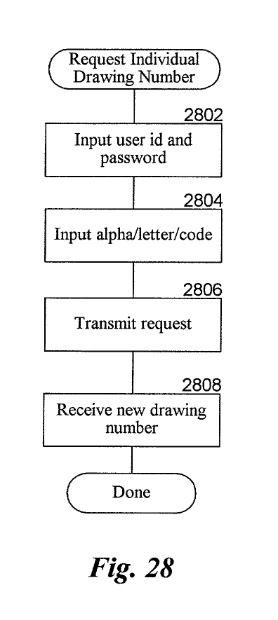

FIG. 28 is a flow diagram illustrating a request by a user for a new drawing number to be issued to him or her. In block 2802, the user identification and password are inputted. In block 2804, the letter code is inputted. The function continues in block 2806, where the request for a new drawing number is transmitted to either a branch bank 2402 or directly to a drawing number repository 2400. In block 2808, user computer 2404 receives the new drawing number. In one embodiment, the new drawing number is received in a generated display page, as described more fully in relation to block 2612 of FIG. 26.

From the foregoing it will be appreciated that although specific embodiments of the drawing number management system have been described herein for purposes of illustration, various modifications may be made without deviating from the spirit and scope of the invention. Accordingly, the invention is not limited except by the appended claims.

1. A drawing number management system comprising:
a drawing number repository for issuing blocks of drawing numbers to branch bank computers, including:
a database for indicating blocks of drawing numbers issued to branch banks, the drawing numbers having a plurality of different formats;
a submission component for receiving requests for an unissued block of drawing numbers of a certain format from a branch bank computer;
a selection component for selecting an unissued block of drawing numbers in accordance with the request received from the branch bank computer by interacting with the database; and
an issuing component for issuing the selected block of drawing numbers; and
a branch bank computer, wherein the branch bank computer and the drawing number server communicate via a computer network, including:
a user submission component for receiving requests for a drawing number from a user on a user computer; and
a request component for transmitting requests for a new block of drawing numbers to the drawing number server when a previously issued block of drawing numbers is depleted; and
a user computer, wherein the user computer and the branch bank computer communicate via a computer network, including:
an input component for receiving a request for a drawing number from a user;
a user submission component for sending to the branch bank computer a request for a new drawing number;
a receiving component for receiving from the branch bank computer an indication of the new drawing number; and
a display component for displaying to the user an indication of the new drawing number.

2. The drawing number management system of claim 1 further comprising an access component in the branch bank computer for specifying rights for particular users to request drawing numbers.

3. The drawing number management system of claim 1 wherein at least one of the drawing numbers is formatted to include one or more strings of numbers and one or more letters.

4. The drawing number management system of claim 1 wherein the database stores information related to at least one organization associated with a block of drawing numbers.

5. The drawing number management system of claim 1 wherein the database stores information related to at least one organization associated with a particular branch bank computer.

6. A drawing number management system comprising:
a drawing number repository for issuing blocks of drawing numbers to branch bank computers including:
a storage means for indicating blocks of drawing numbers issued to branch banks;
a receiving means for receiving requests for an unissued block of drawing numbers;
a selecting means for selecting an unissued block of drawing numbers; and
an issuing means for issuing the selected block of drawing numbers; and
a branch bank computer including:
a receiving means for receiving requests for a drawing number; and
a transmitting means for transmitting requests for a new block of drawing numbers; and
a user computer including:
a receiving means for receiving a request for a drawing number;
a transmission means for sending to the branch bank computer a request for a new drawing number;
a receiving means for receiving from the branch bank computer an indication of the new drawing number; and
a display means for displaying to the user an indication of the new drawing number.

7. A method in a computer system for issuing drawing numbers to a user comprising:
storing information relating to blocks of drawing numbers for issuance to a branch bank in an issued block database;
storing information relating to a plurality of users in a user database;
receiving a request for a drawing number at a branch bank computer from the user on a user computer;
determining at a branch bank computer whether an issued block of drawing numbers associated with the branch bank computer is depleted;
requesting a new issued block of drawing numbers from a drawing number repository for a branch bank computer;
issuing a new block of drawing numbers at a branch bank repository to a branch bank computer in accordance with the request received from the branch bank computer and the information relating to blocks of drawing numbers;
issuing a drawing number to the user from the branch bank computer, wherein the drawing number is based on the information relating to the user; and
displaying to the user at a user computer an indication of the new drawing number.

8. The method of claim 7 further comprising specifying rights for particular branch bank computers to request blocks of drawing numbers.

9. The method of claim 7 wherein at least one of the drawing numbers is formatted to include one or more strings of numbers and one or more letters.

10. The method of claim 7 further comprising receiving information from the branch bank computer indicating at least one part of the drawing number to be included in all drawing numbers in the selected block of drawing numbers.

11. The method of claim 7 further comprising storing information related to at least one organization associated with a particular branch bank computer.

12. A computer-readable medium whose contents cause a computer to issue a drawing number by a method comprising:
storing information relating to blocks of drawing numbers for issuance to a branch bank in an issued block database;
storing information relating to a plurality of users in a user database;
receiving a request for a drawing number at a branch bank computer from the user on a user computer;
determining at a branch bank computer whether an issued block of drawing numbers associated with the branch bank computer is depleted;
requesting a new issued block of drawing numbers for a branch bank computer;
issuing a new block of drawing numbers to a branch bank computer in accordance with the request received from the branch bank computer and the information relating to blocks of drawing numbers;
issuing a drawing number to the user by a branch bank computer, wherein the drawing number is based on the information relating to the user; and
displaying to the user at a user computer an indication of the new drawing number.

13. The computer-readable medium of claim 12 further comprising specifying rights for particular branch bank computers to request blocks of drawing numbers.

14. The computer-readable medium of claim 12 wherein at least one of the drawing numbers is formatted to include one or more strings of numbers and one or more letters.

15. The computer-readable medium of claim 12 further comprising receiving information from the branch bank computer indicating at least one part of the drawing number to be included in all drawing numbers in the selected block of drawing numbers.

16. The computer-readable medium of claim 12 further comprising storing information related to at least one organization associated with a particular branch bank computer.

17. A document number management system in a document number repository comprising:
a database for indicating blocks of document numbers issued to a branch bank computer, the document numbers having a plurality of different formats, wherein the branch bank computer issues individual document numbers to users;
a submission component for receiving requests for an unissued block of document numbers of a certain format from the branch bank computer;
a selection component for selecting an unissued block of document numbers in accordance with the request received from the branch bank computer by interacting with the database;
an issuing component for issuing the selected block of document numbers; and
a transmission component to transmitting an indication of the issued block of document numbers to the branch bank computer, wherein the branch bank computer and the drawing number server communicate via a computer network.

18. The document number management system of claim 17 wherein one or more of the document numbers is a drawing number.

19. The document number management system of claim 18 further comprising an access component for specifying rights for particular branch bank computers to request blocks of drawing numbers.

20. The document number management system of claim 18 wherein further the database stores information related to at least one organization associated with a block of drawing numbers.

21. A document number management system in a document number repository comprising:
a recording means for indicating blocks of document numbers issued to a branch bank computer, wherein the branch bank computer issues individual document numbers to users;
a submission means for receiving requests for an unissued block of document numbers of a certain format from the branch bank computer;
a selection means for selecting an unissued block of document numbers;
an issuing means for issuing the selected block of document numbers; and
a transmission means for transmitting an indication of the issued block of drawing numbers to the branch bank computer.

22. A method in a computer system for issuing a block of document numbers to a branch bank computer comprising:
storing information relating to blocks of document numbers issued to the branch bank computer, the document numbers having a plurality of different formats, wherein the branch bank computer issues individual document numbers to users;
receiving requests for an unissued block of document numbers of a certain format from the branch bank computer;
selecting an unissued block of document numbers in accordance with the request received from the branch bank computer by interacting with the database;
issuing the selected block of document numbers; and
transmitting an indication of the issued block of drawing numbers to the branch bank computer.

23. The method of claim 22 wherein one or more of the document numbers is a drawing number.

24. The method of claim 23 further comprising specifying rights for particular branch bank computers to request blocks of drawing numbers.

25. The method of claim 23 further comprising storing information related to at least one organization associated with a block of drawing number.

26. A computer-readable medium whose contents cause a computer to issue a block of document numbers to a branch bank computer comprising:
storing information relating to blocks of document numbers issued to one or more branch bank computers, the document numbers having a plurality of different formats, wherein the branch bank computer issues individual document numbers to users;
receiving requests for an unissued block of document numbers of a certain format from the branch bank computer;
selecting an unissued block of document numbers in accordance with the request received from the branch bank computer by interacting with the database;
issuing the selected block of document numbers; and
transmitting an indication of the issued block of document numbers to the branch bank computer, wherein the branch bank computer and the drawing number server communicate via a computer network.

27. The computer-readable medium of claim 26 wherein one or more of the document numbers is a drawing number.

28. The computer-readable medium of claim 27 further comprising specifying rights for particular branch bank computers to request blocks of drawing numbers.

29. The computer-readable medium of claim 27 further comprising storing information related to at least one organization associated with a block of drawing number.

30. A document number management system in a branch bank computer comprising:
a user submission component for receiving requests for a document number from a user on a user computer; wherein the branch bank computer and the user computer communicate via a computer network;
a request component for transmitting requests for a new block of document numbers to a document number repository when a previously issued block of drawing numbers is depleted;
a block component for receiving a new block of document numbers from the drawing number repository; and
a transmission component for transmitting an indication of a document number to the user computer.

31. The document number management system of claim 30 wherein at least one of the document numbers is a drawing number.

32. The document number management system of claim 31 further comprising an access component for specifying rights for particular users to request drawing numbers.

33. The document number management system of claim 31 wherein at least one of the drawing numbers is formatted to include one or more strings of numbers and one or more letters.

34. A document number management system in a branch bank computer comprising:
means for receiving requests for a document number from a user on a user computer;
means for transmitting requests for a new block of document numbers to a document number repository when a previously issued block of document numbers is depleted;
means for receiving a new block of document numbers from the drawing number repository;
means for recording an indication of the issuance of a document number in a database; and
means for transmitting an indication of a document number to the user computer.

35. A method in a computer system for issuing a document number to a user comprising:
receiving requests for a document number from a user on a user computer;
transmitting requests for a new block of document numbers to a document number repository when a previously issued block of document numbers is depleted;
receiving a new block of document numbers from the document number repository;
recording an indication of the issuance of a document number to a user in a database; and
transmitting an indication of a document number to the user computer.

36. The method of claim 35 wherein at least one of the document numbers is a drawing number.

37. The method of claim 36 further comprising an access component for specifying rights for particular users to request drawing numbers.

38. The method of claim 36 wherein at least one of the drawing numbers is formatted to include one or more strings of numbers and one or more letters.

39. A computer-readable medium whose contents cause a computer to issue a document number by a method comprising:
receiving requests for a document number from a user on a user computer;
transmitting requests for a new block of document numbers to a document number repository when a previously issued block of document numbers is depleted;
receiving a new block of document numbers from the document number repository;
recording an indication of the issuance of a document number to a user in a database; and
transmitting an indication of a document number to the user computer.

40. The computer-readable medium of claim 39 wherein at least one of the document numbers is a drawing number.

41. The computer-readable medium of claim 40 further comprising an access component for specifying rights for particular users to request drawing numbers.

42. The computer-readable medium of claim 40 wherein at least one of the drawing numbers is formatted to include one or more strings of numbers and one or more letters.

43. A method in a client computer for issuance of a drawing number, the method comprising:
receiving from a user a request for a drawing number to be issued to the user;
sending to a branch bank computer a request that the user is to be issued a drawing number;
receiving from the branch bank computer an indication of the new drawing number; and
displaying to the user an indication of the new drawing number, wherein the branch bank computer, upon receiving the request that the user desires a new drawing number, selects an unissued drawing number and sends an indication of the drawing number to the user computer.

44. The method of claim 43 wherein the request from the user includes a desired format for the drawing number.

45. A drawing number management system on a client computer comprising:
a receiving means for receiving from a user a request for a drawing number to be issued to the user;
a sending means for sending to a branch bank computer a request that the user is to be issued a drawing number;
a receiving means for receiving from the branch bank computer an indication of the new drawing number; and
a displaying means for displaying to the user an indication of the new drawing number, wherein the branch bank computer, upon receiving the request that the user desires a new drawing number, selects an unissued drawing number and sends an indication of the drawing number to the user computer.

46. The drawing number management system of claim 45 wherein the request from the user includes a desired format for the drawing number.

47. A drawing number management system on a client computer comprising:
a receiving component for receiving from a user a request for a drawing number to be issued to the user;
a sending component for sending to a branch bank computer a request that the user is to be issued a drawing number;
a receiving component for receiving from the branch bank computer an indication of the new drawing number; and
a display component for displaying to the user an indication of the new drawing number, wherein the branch bank computer, upon receiving the request that the user desires a new drawing number, selects an unissued drawing number and sends an indication of the drawing number to the user computer.

48. The drawing number management system of claim 47 wherein the request from the user includes a desired format for the drawing number.

49. A computer-readable medium whose contents cause a computer to issue a drawing number by a method comprising:
receiving from a user a request for a drawing number to be issued to the user;
sending to a branch bank computer a request that the user is to be issued a drawing number;
receiving from the branch bank computer an indication of the new drawing number; and
displaying to the user an indication of the new drawing number, wherein the branch bank computer, upon receiving the request that the user desires a new drawing number, selects an unissued drawing number and sends an indication of the drawing number to the user computer.

50. The computer-readable medium of claim 49 wherein the request from the user includes a desired format for the drawing number.

51. A computer-readable medium containing a data structure for use by a drawing number management system, the data structure comprising:
an indication of a drawing number, wherein the drawing number includes
a prefix, a letter, and a suffix.
